(19) United States
(12) Patent Application Publication
(10) Pub. No.: US 2015/0206617 A1
(43) Pub. Date: Jul. 23, 2015

(54) PRODUCTION METHOD FOR A CRYSTALLINE THERMOPLASTIC RESIN COMPOSITION, MANUFACTURING METHOD FOR AN ELECTROPHOTOGRAPHIC MEMBER, AND MANUFACTURING METHOD FOR AN ELECTROPHOTOGRAPHIC BELT

(71) Applicant: CANON KABUSHIKI KAISHA, Tokyo (JP)

(72) Inventor: Toshio Tanaka, Yokohama-shi (JP)

(21) Appl. No.: 14/597,474

(22) Filed: Jan. 15, 2015

(30) Foreign Application Priority Data
Jan. 17, 2014 (JP) 2014-007302

(51) Int. Cl. H01B 1/18; B29D 29/00

(52) U.S. Cl. CPC H01B 1/18; B29D 29/00; B29K 2071/00

(57) ABSTRACT

Provided is a production method for a crystalline thermoplastic resin composition containing dispersed fine particles. The production method includes a step of dispersing fine particles in a crystalline thermoplastic resin while disintegrating agglomerated fine particles by shearing a resin kneaded product that contains the crystalline thermoplastic resin and the agglomerated fine particles and is free of a solvent as a main component. The step includes applying a stress to the resin kneaded product at a temperature that is equal to or more than a Tg of the crystalline thermoplastic resin, and is less than a Tm of the crystalline thermoplastic resin in such a manner that a tan δ of the resin kneaded product at the temperature becomes more than 1.

### BACKGROUND OF THE INVENTION

1. Field of the Invention

The present invention relates to a production method for a crystalline thermoplastic resin composition containing dispersed fine particles, a manufacturing method for an electrophotographic member, and a manufacturing method for an electrophotographic belt.

2. Description of the Related Art

In the case of adding fine particles having various functions to a crystalline thermoplastic resin so as to enhance mechanical properties of the crystalline thermoplastic resin and to allow the crystalline thermoplastic resin to express functions such as conductivity and flame resistance, the functions to be expressed and the homogeneity and stability thereof are influenced by the dispersion state of the fine particles in the crystalline thermoplastic resin.

In particular, in an electroconductive member used in an electrophotographic image forming apparatus, a procedure involving adding electroconductive fine particles to a crystalline thermoplastic resin so as to impart conductivity thereto and controlling the conductivity has been generally employed. In this case, the electroconductive fine particles used for imparting the conductivity includes carbon black (such as acetylene black and ketjen black) and electroconductive metal oxides (such as tin oxide and zinc oxide).

In this case, the dispersion state of the electroconductive fine particles influences the electrical properties such as an electric resistance of the electroconductive member. Therefore, in order to obtain a high-quality printed image with less unevenness, it is necessary to highly disperse the electroconductive fine particles in the crystalline thermoplastic resin.

Although various methods are available as methods of dispersing the fine particles in the crystalline thermoplastic resin, melt-kneading using a twin-screw extruder has been mainly used due to its high productivity. In the melt-kneading involving kneading treatment at a melting point or more of the crystalline thermoplastic resin, the crystalline thermoplastic resin passes through a gap between components that move relatively in the twin-screw extruder so that the fine particles in the crystalline thermoplastic resin receive a shear stress, and the disintegration and distribution of agglomerated fine particles proceed toward a high dispersion state. However, according to the method involving shearing the crystalline thermoplastic resin in a molten state, the viscosity of the crystalline thermoplastic resin is low, and hence a large shear stress cannot be generated.

In view of the foregoing, Japanese Patent Application Laid-Open No. 2002-347020 discloses, as a method of generating a larger shear stress, a method involving cooling a crystalline thermoplastic resin in a molten state in an extruder and shearing the crystalline thermoplastic resin in a semi-solid state having an increased viscosity.

According to the method described in Japanese Patent Application Laid-Open No. 2002-347020, the crystalline thermoplastic resin is sheared in the semi-solid state, and hence a shear stress to be generated is large. However, this method requires a disintegration step in the semi-solid state and a distribution step in the molten state, and hence it is necessary to generate a large temperature difference in the same apparatus. Therefore, there is a problem in that large energy is required for heating and cooling the crystalline thermoplastic resin, which enlarges the apparatus.

### SUMMARY OF THE INVENTION

In view of the foregoing, one embodiment of the present invention is directed to providing a production method for a crystalline thermoplastic resin composition containing dispersed fine particles, which is capable of highly dispersing fine particles in a crystalline thermoplastic resin through use of smaller energy in a smaller apparatus.

Another embodiment of the present invention is directed to providing a manufacturing method for an electrophotographic member that contributes to the formation of a high-quality electrophotographic image.

Still another embodiment of the present invention is directed to providing a manufacturing method for an electrophotographic belt that contributes to the formation of a high-quality electrophotographic image.

According to one embodiment of the present invention, there is provided a production method for a crystalline thermoplastic resin composition containing dispersed fine particles. The production method includes a step of dispersing fine particles in a crystalline thermoplastic resin while disintegrating agglomerated fine particles by shearing a resin kneaded product that contains the crystalline thermoplastic resin and the agglomerated fine particles and is free of a solvent as a main component. The dispersing step includes a step of applying a stress to the resin kneaded product at a temperature that is equal to or more than a glass transition temperature (hereinafter referred to as “Tg”) of the crystalline thermoplastic resin and is less than a melting point (hereinafter referred to as “Tm”) of the crystalline thermoplastic resin in such a manner that a loss tangent (hereinafter referred to as “tan δ”) of the resin kneaded product at the predetermined temperature becomes more than 1.

According to another embodiment of the present invention, there is provided a manufacturing method for an electrophotographic member. The manufacturing method includes the steps of: preparing a crystalline thermoplastic resin composition containing dispersed electroconductive fine particles by the above-mentioned method; and forming an electroconductive resin layer through use of the crystalline thermoplastic resin composition.

According to still another embodiment of the present invention, there is provided a manufacturing method for an electrophotographic belt. The manufacturing method includes the steps of: preparing a crystalline thermoplastic resin composition containing dispersed electroconductive fine particles by the above-mentioned method; and forming the crystalline thermoplastic resin composition into a cylindrical shape.

Further features of the present invention will become apparent from the following description of exemplary embodiments with reference to the attached drawings.

### BRIEF DESCRIPTION OF THE DRAWINGS

FIG. 1 is a schematic view illustrating a production method for a crystalline thermoplastic resin composition containing dispersed fine particles of one embodiment of the present invention.

FIG. 2 is a schematic view illustrating twin-screw kneading for producing a resin kneaded product by the production method for a crystalline thermoplastic resin composition containing dispersed fine particles of one embodiment of the present invention.

FIG. 3 is a graph showing a relationship between a frequency and a tan δ according to Examples of the present invention.

FIG. 4 is a schematic view illustrating cylindrical extrusion forming for producing an electrophotographic belt using for evaluation of dispersibility.

### DESCRIPTION OF THE EMBODIMENTS

Preferred embodiments of the present invention will now be described in detail in accordance with the accompanying drawings.

When a large stress is applied to a thermoplastic resin in a temperature range of a glass transition temperature or more and less than a melting point of the thermoplastic resin, a rheological characteristic is expressed in which a loss tangent (hereinafter sometimes referred to as “tan δ”) of the thermoplastic resin becomes more than 1.

Note that, as used herein, the glass transition temperature is sometimes referred to as “Tg” and the melting point is sometimes referred to as “Tm”. The inventors of the present invention have found that the agglomerated fine particles in the resin kneaded product can be disintegrated and distributed through use of the rheological characteristic so that a crystalline thermoplastic resin composition containing the fine particles that are highly dispersed is obtained.

Specifically, the inventors of the present invention have found the following. When the tan δ of the resin kneaded product becomes more than 1, the loss elastic modulus that is a viscosity component of the resin kneaded product becomes larger than the storage elastic modulus that is an elasticity component of the resin kneaded product. Therefore, strain caused by an applied stress remains in the resin kneaded product as permanent strain without being recovered completely. Thus, in the case where a stress is continuously applied to the resin kneaded product containing the crystalline thermoplastic resin and the agglomerated fine particles in a temperature range of Tg or more and less than Tm of the crystalline thermoplastic resin in such a manner that the tan δ of the resin kneaded product becomes more than 1, the agglomerated fine particles are separated from each other due to the strain caused continuously, and this state is maintained.

Accordingly, the disintegration and distribution of the agglomerated fine particles in the resin kneaded product proceed simultaneously. As a result, a high dispersion state can be obtained.

In the present invention, a stress is applied to the resin kneaded product in a temperature range of Tg or more and less than Tm, in which the viscosity of the thermoplastic resin becomes higher than that of the thermoplastic resin at Tm or more in the molten state, in such a manner that the tan δ of the resin kneaded product becomes more than 1, and hence a shear stress to be generated becomes larger.

Further, the distribution of the agglomerated fine particles proceeds simultaneously with the disintegration thereof, and the state is maintained. Therefore, it is not necessary to re-melt the thermoplastic resin to Tm or more, and problems such as the loss of energy and the enlargement of the apparatus can be solved. Now, one embodiment of the present invention is described with reference to the drawings.

<Production Method for Crystalline Thermoplastic Resin Composition Containing Dispersed Fine Particles>

The step of dispersing fine particles in a crystalline thermoplastic resin in the production method for a crystalline thermoplastic resin composition containing dispersed fine particles according to one embodiment of the present invention is described.

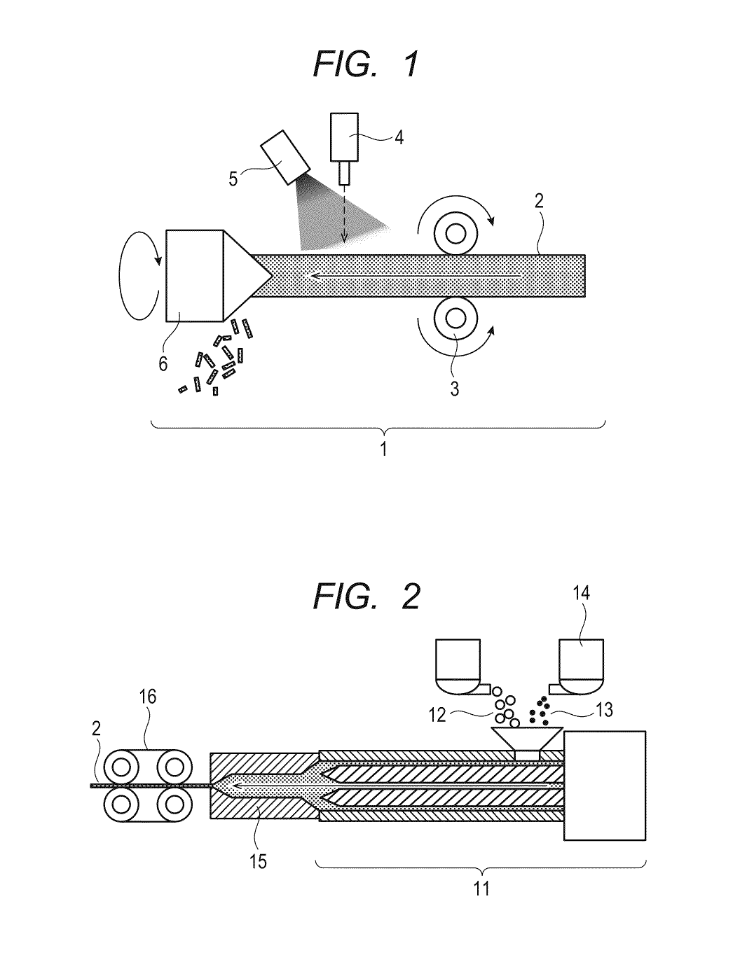

In FIG. 1, a dispersing apparatus 1 feeds a resin kneaded product 2 having a cylindrical shape, which contains a crystalline thermoplastic resin and agglomerated fine particles and is free of a solvent as a main component, in a direction (arrow direction) parallel to a center axis of the resin kneaded product 2 while holding the resin kneaded product 2 with feed rollers 3.

In the present invention, the resin kneaded product that is “free of a solvent as a main component” refers to a resin kneaded product containing a solvent in an amount of 1.0 mass % or less with respect to the total mass of the resin kneaded product.

Then, the surface temperature of the resin kneaded product 2 is measured with a radiation thermometer 4 provided on a downstream side in the feed direction, and the air temperature and flow rate are controlled with an air heater 5 so that the temperature of the resin kneaded product 2 reaches a predetermined temperature of Tg or more and less than Tm of the crystalline thermoplastic resin. A rotation tool 6 having a center axis that is coaxial with the resin kneaded product 2 is provided on a further downstream side from the air heater 5 in the feed direction. The resin kneaded product 2 is fed by the feed rollers 3 and brought into contact with the rotation tool 6.

The rotation tool 6 is rotating at such a speed that the tan δ of the resin kneaded product 2 to be brought into contact with an outermost periphery of the rotation tool 6 becomes more than 1 at a predetermined temperature of Tg or more and less than Tm. The resin kneaded product 2 fed by the feed rollers 3 is brought into contact with the rotation tool 6 so as to be subjected to shear strain, and hence the agglomerated fine particles contained in the resin kneaded product 2 are disintegrated and distributed.

Further, a portion of the resin kneaded product 2 subjected to shear strain is deformed in a radial direction so as to become small pieces due to the centrifugal force of the rotation tool 6 which the portion is brought into contact, and is released from the resin kneaded product 2. During the deformation and release of the portion, the crystalline thermoplastic resin and the fine particles positioned in the vicinity of the center axis of the resin kneaded product 2 also move in an outer peripheral direction of the rotation tool 6 and are brought into contact with the outermost periphery of the rotation tool 6. Thus, the crystalline thermoplastic resin and the fine particles contained in the resin kneaded product 2 are all to be subjected to the equal maximum shear stress irrespective of their positions. Accordingly, a crystalline thermoplastic resin composition containing dispersed fine particles can be obtained.

<Resin Kneaded Product>

In FIG. 2, a crystalline thermoplastic resin 12 and fine particles 13 are respectively fed to a twin-screw extruder by weight feeders 14. The crystalline thermoplastic resin 12 and the fine particles 13 are kneaded with the twin-screw extruder 11 and extruded into a cylindrical shape so that the resin kneaded product 2 is produced. The outer diameter of the resin kneaded product 2 can be appropriately adjusted by a take-up speed of a take-up device 16.

<Crystalline Thermoplastic Resin>

Examples of the crystalline thermoplastic resin according to the present invention include polyether ether ketone and polyphenylene sulfide.

<Fine Particles>

Specific examples of the electroconductive particles in the case where the electroconductive fine particles are used as the fine particles according to the present invention include carbon black (such as acetylene black and ketjen black) and electroconductive metal oxides (such as tin oxide and zinc oxide).

<Electrophotographic Member>

An endless electrophotographic belt having an electroconductive resin layer was produced by cylindrical extrusion forming using a single-screw extruder 21 and a cylindrical die 22 illustrated in FIG. 4 through use of the crystalline thermoplastic resin composition containing dispersed fine particles prepared in the foregoing. The endless electrophotographic belt can be used as an intermediate transfer belt, a transfer conveyance belt, or the like in which the dispersion state of electroconductive particles significantly influences the quality of a printed image among electrophotographic members.

Specifically, the crystalline thermoplastic resin composition containing dispersed fine particles obtained in the foregoing is fed to the single-screw extruder 21 by the weight feeder 14. The crystalline thermoplastic resin composition in a molten state to be discharged is extruded from the cylindrical die 22 through a gear pump 23 so as to be taken up by a cylindrical take-up device 25. The crystalline thermoplastic resin composition is brought into contact with a cooling mandrel 24 provided between the cylindrical die 22 and the cylindrical take-up device 25 while being taken up. Thus, the crystalline thermoplastic resin composition is cooled and solidified. The resultant crystalline thermoplastic resin composition is cut with a cylindrical cutting machine 26 set below the cylindrical take-up device 25, and thus an intermediate transfer belt can be obtained.

<Measurement Method for Tg and Tm>

Values of the Tg and Tm of the crystalline thermoplastic resin can be determined by the following method.

As a measurement device, a differential scanning calorimeter (trade name: Q2000, manufactured by TA Instruments Japan Inc.) is used.

The Tg is measured as follows through use of the differential scanning calorimeter in accordance with ISO 11357. A pellet of the crystalline thermoplastic resin to be measured is cut into pieces measuring 0.5 mm or less on a side and filled into a sample pan dedicated for the measurement device so as to weight 10.0 mg. While nitrogen gas is supplied at 10 ml per minute to a measurement space, the temperature of the measurement space is raised from room temperature to a temperature higher by 50° C. than the glass transition temperature indicated by each resin manufacturer at a speed of 10° C. per minute so that a heat flow curve is obtained. In the heat flow curve, the temperature at an intersection between the intermediate line drawn at positions with an equal interval from respective base lines before and after glass transition and the heat flow curve is defined as the Tg.

The Tm is measured as follows through use of the differential scanning calorimeter in accordance with ISO 11357. A pellet of the crystalline thermoplastic resin to be measured is cut into pieces measuring 0.5 mm or less on a side and filled into a sample pan dedicated for the measurement device so as to weight 5.0 mg. While nitrogen gas is supplied at 10 ml per minute to a measurement space, the temperature of the measurement space is raised from room temperature to a temperature higher by 50° C. than the melting point indicated by each resin manufacturer at a speed of 10° C. per minute so that a heat flow curve is obtained. In the heat flow curve, an apex of a peak indicating dissolution is defined as the Tm.

<Measurement Method for Rheological Characteristic of Resin Kneaded Product Containing Crystalline Thermoplastic Resin and Agglomerated Fine Particles>

The rheological characteristic of a resin kneaded product containing a crystalline thermoplastic resin and agglomerated fine particles can be determined by the following method.

As a measurement device, a dynamic viscoelasticity measurement device (trade name: Rheogel-E4000, manufactured by UBM Co., Ltd.) is used.

A measurement sample is set to have a thickness of 50 μm, a width of 5.0 mm, and a length of 30 mm. The measurement sample is fixed to a measurement jig for tensioning included with the measurement device at such a position that a chuck-to-chuck distance becomes 20 mm, and heated with a constant temperature reservoir included with the measurement device. After the temperature of the measurement sample reaches a setting temperature, the measurement sample is held for 120 seconds so as to stabilize the temperature of the measurement sample, and then is subjected to a strain of 1.0% in order to provide enough amount of displacement to the agglomerated fine particles in the sample. That is, the size of the agglomerated particles in the sample, and the distance between the agglomerated fine particles in the sample are substantially several microns, thus, by applying the strain of 1.0% to the sample held at the chuck-to-chuck distance of 20 mm, enough amount of displacement with respect to the agglomerated fine particles in the sample is provided.

In order to cause the strain in the measurement sample by a tensile force, tension and relaxation of the measurement sample are repeated with sine vibration. The frequency of the sine vibration is changed from 1 to 1,000 [Hz] in stages so as to perform measurement, with the result that a tan δ at each frequency is determined. The above-mentioned measurement is performed by changing the setting temperature so that the tan δ of each sample and the relationship between the temperature and the frequency can be obtained.

According to one embodiment of the present invention, the agglomerated fine particles in the resin kneaded product can be disintegrated and distributed with a shear stress larger than that of conventional melt-kneading. Thus, a production method capable of producing a crystalline thermoplastic resin composition containing dispersed fine particles with less energy in a smaller device can be provided. Further, according to one embodiment of the present invention, an electrophotographic member in which fine particles are dispersed in a crystalline thermoplastic resin can be obtained.

### EXAMPLES

Now, the present invention is described more specifically by way of Examples.

### Example 1

### Production of Resin Kneaded Product

A resin kneaded product containing a crystalline thermoplastic resin and agglomerated fine particles in the present invention was obtained by subjecting materials to twin-screw kneading using the twin-screw extruder 11 (trade name: PCM30, manufactured by Ikegai Corp) illustrated in FIG. 2 and extruding the resultant into a cylindrical shape. Polyether ether ketone (trade name: VICTREX (trademark) PEEK450G, manufactured by Victrex plc) was used as the crystalline thermoplastic resin 12, and acetylene black (trade name: DENKA BLACK (trademark) particulate product, manufactured by DENKI KAGAKU KOGYO KABUSHIKI KAISHA) was used as the fine particles 13.

The Tg and Tm of polyether ether ketone were determined to be 143° C. and 343° C., respectively, by the above-mentioned measurement method.

Polyether ether ketone and acetylene black were fed to the twin-screw extruder 11, respectively, through use of the weight feeders 14 so that the amounts of polyether ether ketone and acetylene black were 80 mass % and 20 mass %, respectively. As a cylinder setting temperature of the twin-screw extruder 11, the temperature of a material feed portion was set to 320° C., and the temperatures of a cylinder downstream portion and a die 15 were each set to 360° C. The screw rotation number of the twin-screw extruder 11 was set to 300 rpm, and the material feed amount was set to 8 kg/h. The inner diameter of the die 15 was 20 mm, and hence the outer diameter of the resin kneaded product 2 was appropriately adjusted to be 14 mm by the take-up speed of the take-up device 16.

<Forming of Sheet Sample>

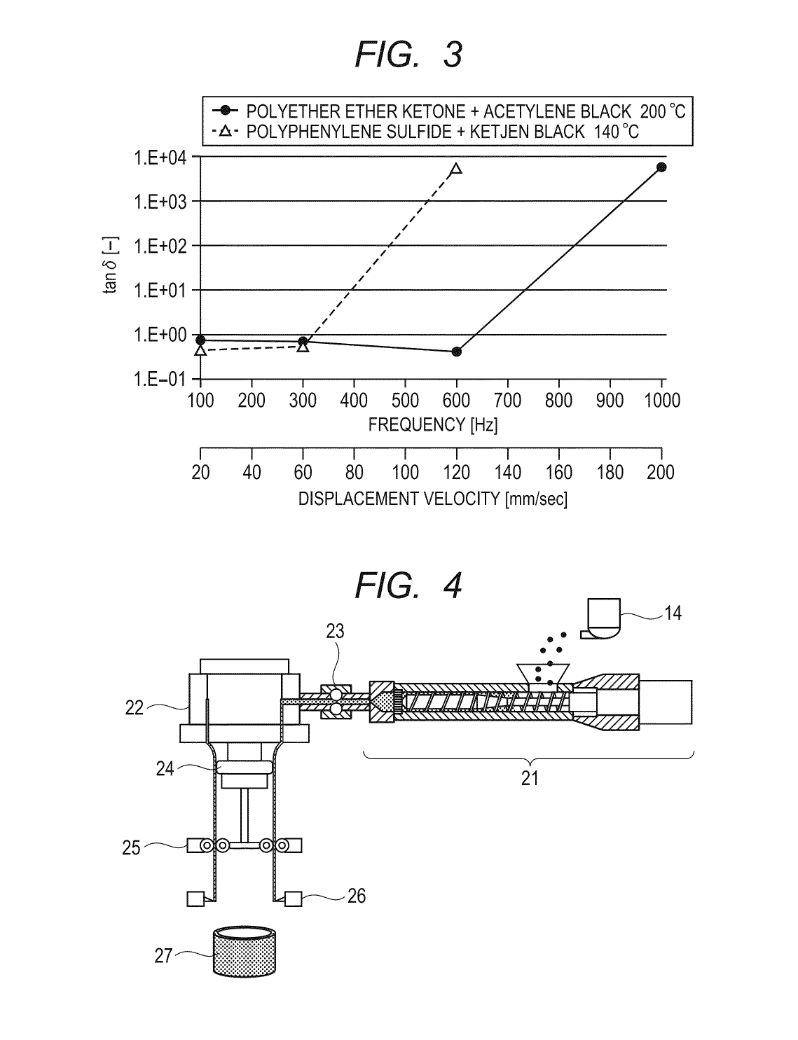

Further, a sheet sample was also formed for evaluating the rheological characteristic of the resin kneaded product. The sheet sample was formed by using a slit die having a rectangular opening with dimensions of 300 mm×1 mm in the twin-screw extruder 11. The kneading conditions were the same as those of the above-mentioned resin kneaded product, and the take-up speed of the take-up device 16 was appropriately adjusted so that the sheet thickness became 50 μm. The sheet sample thus obtained was measured for the rheological characteristic by the above-mentioned measurement method at a measurement temperature of 200° C., with the result that the value of a tan δ at each frequency as illustrated in FIG. 3 was obtained. Further, the values of FIG. 3 are determined under the conditions of a chuck-to-chuck distance of 20 mm and a strain of 1.0%, and hence the frequency can be represented as displacement velocity as illustrated in the lower portion of the horizontal axis. Here, the relationship between the frequency and the displacement velocity are obtained by the following equation.

Displacement velocity=frequency[Hz]×the amount of displacement[mm]

The amount of displacement can be calculated from the chuck-to-chuck distance and a strain when measuring Rheological Characteristic as mentioned above. For example, when the chuck-to-chuck distance is 20 mm and the strain is 1.0%, the amount of displacement is 0.2 mm (=(1/100)×20 mm).

<Production of Crystalline Thermoplastic Resin Composition Containing Dispersed Fine Particles (Dispersion Treatment Step)>

The cylindrical-shaped resin kneaded product having a diameter of 14 mm obtained in the foregoing was subjected to a step of dispersing fine particles in a crystalline thermoplastic resin (hereinafter sometimes referred to as “dispersion treatment step”) through use of the dispersing apparatus 1 illustrated in FIG. 1. The temperature of the resin kneaded product 2 was controlled so as to be 200° C. through use of the radiation thermometer 4 and the air heater 5. The rotation tool 6 has a diameter of 30 mm and is formed of an alloy tool steel material (SKD).

It is understood from FIG. 3 that, in the resin kneaded product formed of polyether ether ketone and acetylene black at a temperature of 200° C., the tan δ becomes more than 1 when the frequency is set to 625 [Hz] and the displacement velocity is set to 125 mm/sec or more, and thus the effect of the present invention can be obtained. Considering this, the rotation number of the rotation tool 6 was set to 185 rpm so that the circumferential velocity of a contact portion of an outermost periphery in the rotation tool 6 with respect to the resin kneaded product 2 became 135 mm/sec with respect to the rotation tool 6. Note that, the feed speed of the resin kneaded product 2 in a direction parallel to a center axis of the resin kneaded product 2 was set to 90 mm/min.

Through the dispersion treatment step, a crushed product released from the resin kneaded product and turned into small pieces was collected.

### Example 2

A cylindrical-shaped resin kneaded product having a diameter of 14 mm was obtained by the method described in the <Production of resin kneaded product> section in Example 1. The dispersion treatment step was performed under the same conditions as those of the dispersion treatment step of Example 1, except for setting the rotation number of the rotation tool 6 to 2,000 rpm so that the circumferential velocity of the contact portion of the outermost periphery in the rotation tool 6 with respect to the resin kneaded product 2 became 1,460 mm/sec with respect to the rotation tool 6 in the dispersion treatment step of Example 1.

Through the dispersion treatment step, a crushed product released from the resin kneaded product and turned into small pieces was collected.

### Example 3

### Production of Resin Kneaded Product

Polyphenylene sulfide (trade name: DURAFIDE (trademark) (formerly FORTRON) 0220A9, manufactured by POLYPLASTICS CO., LTD.) was used as the crystalline thermoplastic resin, and ketjen black (trade name: Ketjen Black EC300J, manufactured by Lion Corporation) was used as the fine particles.

The Tg and Tm of polyphenylene sulfide were determined to be 90° C. and 280° C., respectively, by the above-mentioned measurement method.

The amounts of polyphenylene sulfide and ketjen black were set to 88 mass % and 12 mass %, respectively. As a cylinder setting temperature of the twin-screw extruder 11, the temperature of a material feed portion was set to 250° C., and the temperatures of a cylinder downstream portion and a die 15 were each set to 300° C. A cylindrical-shaped resin kneaded product having a diameter of 14 mm was obtained by setting the other conditions of the twin-screw extruder 11 in the same way as in Example 1.

Then, the resin kneaded product according to this example was evaluated for the rheological characteristic in the same way as in Example 1.

Further, the cylindrical-shaped resin kneaded product obtained as described above was subjected to a dispersion treatment step. In this case, it is understood from FIG. 3 that, in the resin kneaded product formed of polyphenylene sulfide and ketjen black at a temperature of 140° C., the tan δ becomes more than 1 when the frequency is set to 325 [Hz] and the displacement velocity is set to 65 mm/sec or more, and thus the effect of the present invention can be obtained.

Considering this, in the dispersion treatment step according to this example, the temperature of the resin kneaded product was set to 140° C., and the rotation number of the rotation tool 6 was set to 100 rpm so that the circumferential velocity of a contact portion of an outermost periphery in the rotation tool 6 with respect to the resin kneaded product 2 became 73 mm/sec with respect to the rotation tool 6. Further, the other conditions in the dispersion treatment step were set to be the same as those of Example 1.

Through the dispersion treatment step, a crushed product released from the resin kneaded product and turned into small pieces was collected.

### Example 4

A cylindrical-shaped resin kneaded product having a diameter of 14 mm was obtained by the method described in the <Production of resin kneaded product> section in Example 3. The dispersion treatment step was performed under the same conditions as those of the dispersion treatment step of Example 3, except for setting the rotation number of the rotation tool 6 to 2,000 rpm so that the circumferential velocity of the contact portion of the outermost periphery in the rotation tool 6 with respect to the resin kneaded product 2 became 1,460 mm/sec with respect to the rotation tool 6 in the dispersion treatment step of Example 3.

Through the dispersion treatment step, a crushed product released from the resin kneaded product and turned into small pieces was collected.

### Comparative Example 1

A cylindrical-shaped resin kneaded product having a diameter of 14 mm was obtained by the method described in the <Production of resin kneaded product> section in Example 1.

Then, the cylindrical-shaped resin kneaded product thus obtained was subjected to dispersion treatment through use of the dispersing apparatus used in the dispersion treatment step of Example 1. Note that, as the dispersion treatment condition, the tan δ of the resin kneaded product was adjusted so as to be less than 1. Specifically, the rotation number of the rotation tool 6 was set to 150 rpm so that the circumferential velocity of a contact portion of an outermost periphery in the rotation tool 6 with respect to the resin kneaded product 2 became 110 mm/sec with respect to the rotation tool 6. The other conditions were set to be the same as those in the dispersion treatment step of Example 1.

Through the dispersion treatment step, a crushed product released from the resin kneaded product and turned into small pieces was collected.

### Comparative Example 2

A cylindrical-shaped resin kneaded product was prepared in accordance with the production step of the resin kneaded product of Example 1. Note that, the take-up speed of the take-up device 16 was adjusted so that the diameter of the cylindrical-shaped resin kneaded product became 2 mm.

Then, the resin kneaded product thus obtained was cut into a pellet having a length of 3 mm with a cutting machine.

The pellet thus obtained was subjected to twin-screw kneading under the same conditions (cylinder temperature of twin-screw kneader: 360° C., screw rotation number: 300 rpm) as the kneading conditions in the production step of the resin kneaded product of Example 1. Consequently, a cylindrical-shaped resin kneaded product having a diameter of 2 mm was produced. The cylindrical-shaped resin kneaded product was cut into a pellet having a length of 3 mm with the cutting machine.

### Example 5

A resin kneaded product according to this example was prepared in the same way as in the production step of the resin kneaded product of Example 3, except for substituting, as fine particles, tin oxide (trade name: Passtran TYPE-IV Tin Oxide, manufactured by Mitsui Mining & Smelting Co., Ltd.) for ketjen black in the production step of the resin kneaded product of Example 3.

The resin kneaded product thus prepared was subjected to dispersion treatment under the same conditions as those of the dispersion treatment step of Example 4.

Through the dispersion treatment step, a crushed product released from the resin kneaded product and turned into small pieces was collected.

### Comparative Example 3

A cylindrical-shaped resin kneaded product having a diameter of 14 mm was prepared in accordance with the production step of the resin kneaded product of Example 3.

Then, the resin kneaded product thus obtained was subjected to dispersion treatment through use of the dispersing apparatus used in the dispersion treatment step of Example 3. Note that, as the dispersion treatment condition, the tan δ of the resin kneaded product was adjusted so as to be less than 1. Specifically, the rotation number of the rotation tool 6 was set to 80 rpm so that the circumferential velocity of a contact portion of an outermost periphery in the rotation tool 6 with respect to the resin kneaded product became 58.6 mm/sec with respect to the rotation tool 6. The other conditions were set to be the same as those in the dispersion treatment step of Example 3.

Through the dispersion treatment step, a crushed product released from the resin kneaded product and turned into small pieces was collected.

### Comparative Example 4

A cylindrical-shaped resin kneaded product was prepared in accordance with the production step of the resin kneaded product of Example 3. Note that, the take-up speed of the take-up device 16 was adjusted so that the diameter of the cylindrical-shaped resin kneaded product became 2 mm.

Then, the resin kneaded product thus obtained was cut into a pellet having a length of 3 mm with a cutting machine.

The pellet thus obtained was subjected to twin-screw kneading under the same conditions (cylinder temperature of twin-screw kneader: 300° C., screw rotation number: 300 rpm) as the kneading conditions in the production step of the resin kneaded product of Example 3. Consequently, a cylindrical-shaped resin kneaded product having a diameter of 2 mm was produced. The cylindrical-shaped resin kneaded product was cut into a pellet having a length of 3 mm with the cutting machine.

<Measurement of Content of Solvent>

(Preparation of Samples) A resin kneaded product was washed with ethanol, then, the resultant was cut by knife into slices of 20 mg.

(Heating Condition)

The cut slice of the resin kneaded product was set in a container having a helium gas supply port and absorption pipe connection. Next, the container was heated in an electric furnace. The heating conditions were as follows.

Temperature: 300° C.

Heating time: 15 minutes

Heating atmosphere: He gas (50 ml/min)

An absorption material (trade name: Tenax-GR, manufactured by GL Sciences Inc.) was included in the absorption pipe connected with the container to absorb and collect solvent component vaporized by heating.

(Measurement Method of Thermal Desorption GC/MS)

The absorption pipe treated under the above heating conditions was analyzed in thermal desorption GC/MS under the following conditions and apparatus, then, absorbed and collected solvent component was identified. Pyrolyzer apparatus: JTD-505II (manufactured by Japan Analytical Industry Co., Ltd.)

Primary thermal desorption conditions: desorption temperature 260° C., trap temperature −60° C., 15 min; Secondary thermal desorption conditions: 280° C., 180 sec; GC apparatus: HP6890 manufactured by Agilent Company; MS apparatus: JMS-SX102A manufactured by JEOL Ltd.; Column: DB-5MS (length 30 m, inner diameter 0.25 mm, thickness 0.5 μm, manufactured by Agilent Technologies, Inc.(J&W Scientific))

Column temperature: after keeping at 60° C. for 5 minutes, heating up to 300° C. by a rate of 8° C./min, then keeping 25 minutes

Carrier gas: helium gas, flow rate:1.5 ml/min; Ionization method: EI

(Preparation of Calibration Curve)

Quantitative analysis of adsorbed and collected organic solvent component was calculated by the following method. Ethanol was added to toluene of the standard preparation to prepare the standard solutions with 6 levels concentrations which were different from each other. Then, standard solutions were analyzed under the same conditions as samples. The absolute amounts (weights) of each component were obtained by the concentration of standard solution and injected amount for analysis. A calibration curve was prepared by the relationship between the absolute amount and peak area of total ion chromatogram. Then, quantitative calculation was subjected.

<Evaluation of Dispersibility>

The crushed products collected in Examples 1 to 5 and Comparative Examples 1 and 3 and the pellets produced in Comparative Examples 2 and 4 were subjected to cylindrical extrusion forming through use of a cylindrical extruder illustrated in FIG. 4 so as to produce belts for evaluating dispersibility.

In this case, the cylindrical extrusion forming was performed through use of the single-screw extruder 21 (trade name: GT40, manufactured by Research Laboratory of Plastics Technology Co., Ltd.) and the cylindrical die 22 having a circular opening with a diameter of 300 mm and a gap of 1 mm. The above-mentioned crushed products and pellets were fed to the single-screw extruder 21 by the weight feeder 14 in a feed amount of 4 kg/h. The cylinder setting temperature of the single-screw extruder 21 was set to be the same as the setting temperature of the cylinder downstream portion of the twin-screw extruder 11 in Examples and Comparative Examples described above.

The crystalline thermoplastic resin composition in a molten state discharged from the single-screw extruder was extruded from the cylindrical die 22 through the gear pump 23 so as to be taken up by the cylindrical take-up device 25 at such a speed that the thickness of the crystalline thermoplastic resin composition became 50 μm. The crystalline thermoplastic resin composition was brought into contact with the cooling mandrel 24 provided between the cylindrical die 22 and the cylindrical take-up device while being taken up. Thus, the crystalline thermoplastic resin composition was cooled and solidified. The solidified crystalline thermoplastic resin composition was cut so as to have a width of 300 mm with the cylindrical cutting machine 26 set below the cylindrical take-up device 25, and thus a belt 27 was obtained.

The respective endless belts according to Examples 1 to 5 and Comparative Examples 1 to 4, produced through use of the crushed products collected in Examples 1 to 5 and Comparative Examples 1 and 3 and the pellets produced in Comparative Examples 2 and 4, were evaluated for the dispersion state of fine particles in the belt by the following method. Specifically, the belts according to Examples and Comparative Examples were cut in a width direction. Each image of the cut cross sections was obtained with an electron microscope (trade name: XL30-SFEG, manufactured by Philips), and the number of particles for each particle diameter was counted from the image. Cross section images were obtained at ten points for each belt at a magnification of 20,000 times (field of view: 6.2 μm×4.7 μm), and the number of the particles were determined from the total of the images.

Table 1 shows the results of the evaluation of dispersibility.

In the belts according to Examples 1, 2, 3, 4, and 5, no coarse fine particles having a particle diameter of 700 nm or more were found, and the number of fine particles having a particle diameter of 300 nm or less was large. It was found from this result that the agglomerated fine particles were disintegrated and distributed and were highly dispersed in the crystalline thermoplastic resin.

On the other hand, in the belts according to Comparative Examples 1, 2, 3, and 4, coarse particles having a particle diameter of 700 nm or more remained, and compared to Examples, the number of fine particles having a particle diameter of 300 nm or less was small. Thus, it was found that the agglomerated fine particles were not sufficiently disintegrated.

<Evaluation of Image>

Further, the belts according to Examples and Comparative Examples were mounted as an intermediate transfer belt on an electrophotographic printer (trade name: LBP9500C, manufactured by Canon, Inc.). A solid image of cyan was output on 5,000 sheets continuously through use of the printer. The presence or absence of unevenness in the 5,000th solid image was visually checked.

Table 1 shows the results.

The images output through use of the belts according to Examples 1, 2, 3, 4, and 5 were high-quality images without color unevenness.

In contrast, color unevenness occurred in the images output through use of the belts according to Comparative Examples 1, 2, 3, and 4.

TABLE 1

| | | | | | | | | | | Twin-screw |
|---|---|---|---|---|---|---|---|---|---|---|
| | | | | | | | | | | kneading + |
| | | | | | Two | | | | | Treatment |
| | | Twin-screw kneading + | | | treatments | Twin-screw kneading + | | | | using |
| | | Treatment using dispersing | | | by twin- | Treatment using dispersing | | | Two treatments | dispersing |
| | | apparatus illustrated in | | | screw | apparatus illustrated in | | | by twin-screw | apparatus |
| | | FIG. 1 | | | kneading | FIG. 1 | | | kneading | illustrated |
| | | | | Com- | Com- | | | Com- | Com- | in |
| | | | | parative | parative | | | parative | parative | FIG. 1 |
| Condition | | Example 1 | Example 2 | Example 1 | Example 2 | Example 3 | Example 4 | Example 3 | Example 4 | Example 5 |
| Material | Thermoplastic | Polyether ether ketone | | | | Polyphenylene sulfide | | | | Poly- |
| | resin | 80 wt % | | | | 88 wt % | | | | phenylene |
| | | | | | | | | | | sulfide |
| | | | | | | | | | | 91 wt % |
| | Particle | Acetylene black | | | | Ketjen black | | | | Tin oxide |
| | | 20 wt % | | | | 12 wt % | | | | 9 wt % |
| Dispersing | Apparatus | Dispersing apparatus | | | Twin- | Dispersing apparatus | | | Twin-screw | Dispersion |
| treatment | configuration | illustrated in FIG. 1 | | | screw | illustrated in FIG. 1 | | | kneader | apparatus |
| | | | | | kneader | | | | | illustrated in |
| | | | | | | | | | | FIG. 1 |
| | Condition | 200° C. | 200° C. | 200° C. | 360° C. | 140° C. | 140° C. | 140° C. | 300° C. | 140° C. |
| | | 185 rpm | 2,000 rpm | 150 rpm | 300 rpm | 100 rpm | 2,000 rpm | 80 rpm | 300 rpm | 2,000 rpm |
| | Outer | 135 | 1,460 | 110 | — | 73 | 1,460 | 58.6 | — | 1,460 |
| | circumferential | | | | | | | | | |
| | velocity of | | | | | | | | | |
| | rotation tool | | | | | | | | | |
| | (mm/sec) | | | | | | | | | |
| | tanδ | 3 | 5,700 | 0.5 or less | — | 3 | 5,700 | 0.5 or less | — | 5,700 or |
| | (solid phase | | or | | (molten | | or | | (molten state) | more |
| | state) | | more | | state) | | more | | | |
| Formation into | Apparatus | Single-screw extruder + cylindrical die | | | | Single-screw extruder + cylindrical die | | | | Single-screw |
| belt | configuration | | | | | | | | | extruder + |
| | | | | | | | | | | cylindrical |
| | | | | | | | | | | die |
| | Condition | 360° C. | | | | 300° C. | | | | 300° C. |
| Amount of solvent | | 1.0 mass % or less | | | | 1.0 mass % or less | | | | 1.0 mass % |
| | | | | | | | | | | or less |
| Evaluation of | 700 nm~ | 0 | 0 | 63 | 16 | 0 | 0 | 79 | 23 | 0 |
| dispersibility | ~300 nm | 870 | 1,350 | 45 | 320 | 830 | 960 | 65 | 240 | 790 |
| (number of | | | | | | | | | | |
| particles) | | | | | | | | | | |
| Evaluation of | Presence/absence | Absent | Absent | Present | Present | Absent | Absent | Present | Present | Absent |
| image | of color | | | | | | | | | |
| | unevenness | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-007302, filed Jan. 17, 2014, which is hereby incorporated by reference herein in its entirety.

What is claimed is:

1. A production method for a crystalline thermoplastic resin composition containing dispersed fine particles,
the production method comprising a step of dispersing fine particles in a crystalline thermoplastic resin while disintegrating agglomerated fine particles by shearing a resin kneaded product that contains the crystalline thermoplastic resin and the agglomerated fine particles and is free of a solvent as a main component, wherein
the step comprises
an applying step in which a stress is applied to the resin kneaded product at a temperature that is equal to or more than a glass transition temperature of the crystalline thermoplastic resin, and is less than a melting point of the crystalline thermoplastic resin in such a manner that a loss tangent of the resin kneaded product at the predetermined temperature becomes more than 1.

2. A production method for a crystalline thermoplastic resin composition according to claim 1, wherein the crystalline thermoplastic resin comprises one of polyether ether ketone and polyphenylene sulfide.

3. A production method for a crystalline thermoplastic resin composition according to claim 1, wherein the fine particles comprise electroconductive fine particles.

4. A production method for a crystalline thermoplastic resin composition according to claim 3, wherein the electroconductive fine particles comprise one of carbon black and electroconductive metal oxides.

5. A manufacturing method for an electrophotographic member including an electroconductive resin layer,
the manufacturing method comprising:
preparing a crystalline thermoplastic resin composition containing dispersed electroconductive fine particles by the production method according to claim 3; and
producing the electroconductive resin layer through use of the crystalline thermoplastic resin composition.

6. A manufacturing method for an electrophotographic belt having an endless shape and comprising an electroconductive resin layer,
the manufacturing method comprising steps of:
preparing a crystalline thermoplastic resin composition containing dispersed electroconductive fine particles by the production method according to claim 3; and
forming the crystalline thermoplastic resin composition into a cylindrical shape.
